(19) United States
(12) Patent Application Publication
(10) Pub. No.: US 2007/0157311 A1
(43) Pub. Date: Jul. 5, 2007

(54) Security modeling and the application life cycle

(75) Inventors: John D. Meier, Bellevue, WA (US); Anandha S. Murukan, Bellevue, WA (US); Srinath Vasireddy, Issaquah, WA (US); Blaine Wastell, Woodinville, WA (US); Michael Dunner, Renton, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/321,425

(22) Filed: Dec. 29, 2005

(51) Int. Cl. G06F 12/14

(52) U.S. Cl. 726/22

(57) ABSTRACT

A security engineering system and methodology associated with the application life cycle is provided. The subject innovation provides a threat modeling system can be employed to identify threats and vulnerabilities associated with stages of the application life cycle. In accordance therewith, the novel innovation can facilitate identification of common issues that can arise during a threat modeling activity. The innovation can provide for a systematic mechanism to identify threats and/or vulnerabilities in accordance with the application life cycle.

### BACKGROUND

Analysis of software systems has proven to be extremely useful to development requirements and to the design of systems. As such, it can be particularly advantageous to incorporate security engineering and analysis into the software development life cycle from the beginning stage of design. Conventionally, the application life cycle lacks security engineering and analysis thereby prompting retroactive measures to address identified issues.

Today, when developing an application, it is oftentimes difficult to predict how the application will react under real-world conditions. In other words, it is difficult to predict security vulnerabilities of an application prior to and during development and/or before completion. Frequently, upon completion, a developer will have to modify the application in order to adhere to real-world conditions and threats of attacks. This modification can consume many hours of programming time and delay application deployment—each of which is very expensive.

Traditionally, designing for application security is oftentimes random and does not produce effective results. As a result, applications and data associated therewith are left vulnerable to threats and uninvited attacks. In most cases, the typical software practitioner lacks the expertise to effectively predict vulnerabilities and associated attacks.

While many threats and attacks can be estimated with some crude level of certainty, others cannot. For those security criterions that can be estimated prior to development, this estimate most often requires a great amount of research and guesswork in order to most accurately determine the criterion. The conventional guesswork approach of security analysis is not based upon any founded benchmark. As well, these conventional approaches are not effective or systematic in any way.

In accordance with traditional application life cycle development, it is currently not possible to proactively (and accurately) address security issues from the beginning to the end of the life cycle. To the contrary, developers often find themselves addressing security issues after the fact—after development is complete. This retroactive security modeling approach is extremely costly and time consuming to the application life cycle.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a security engineering system and methodology associated with the application life cycle. In one particular aspect, a threat modeling system and/or methodology can be employed to identify threats and vulnerabilities associated with stages of the application life cycle. In accordance therewith, the novel innovation can facilitate identification of issues that can arise during a threat modeling activity.

Threat modeling can be difficult for a number of reasons. One common mistake that a typical user makes is to spend too much time trying to solve problems instead of identifying threats. Another common mistake is to spend too much time in the early analysis and fact-finding steps of the activity and to fail to spend enough time on a particularly important step: threat identification. The subject innovation can provide for a systematic mechanism to identify threats in accordance with the application life cycle.

In one aspect, a system that facilitates security engineering of an application life cycle includes a threat modeling component that can generate a threat model of the application life cycle based at least in part upon an input. In disparate aspects, the input can be a use case, usage scenario, data flow, data schema, deployment diagram, etc.—all associated with the application life cycle.

In another aspect, the threat modeling component can include a security objectives definition component that can establish a security objective based at least in part upon a criterion of the architecture of the application. Furthermore, the threat modeling component can include an analyzer component that evaluates the application architecture and a security issue identifier that determines at least one of a threat and a vulnerability based at least in part upon an output of the analyzer component.

In still another aspect, an application overview component and/or an application decomposition component can be provided. These components can assist in the determination of a threat and/or vulnerability associated with the application life cycle.

In yet another aspect, the security issue identifier component can include a threat identifier and/or a vulnerability identifier that determines the threat and/or vulnerability based at least in part upon the scenario. More particularly, the vulnerability identifier can facilitate review one or more layers of the application and determination of a weakness based at least in part upon a threat.

Still another aspect of the innovation employs an artificial intelligence (AI) component that infers an action that a user desires to be automatically performed. More particularly, an AI component can be provided and employ a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates security modeling in accordance with an aspect of the innovation.

FIG. 2 illustrates a system that employs a security objectives definition component, an analyzer component and a security issue identifier component in accordance with a novel security modeling system.

FIG. 3 illustrates an exemplary security modeling component having multiple components therein which facilitate performance modeling in accordance with the novel innovation.

FIG. 4 illustrates an exemplary flow chart of procedures that facilitate threat modeling in accordance with an aspect of the innovation.

FIG. 5 illustrates an exemplary flow chart of procedures that facilitate identifying security objectives in accordance with an aspect of the innovation.

FIG. 6 illustrates an exemplary flow chart of procedures that facilitate creating an application overview in accordance with an aspect of the innovation.

FIG. 7 illustrates an exemplary end-to-end diagram of an application in accordance with an aspect of the innovation.

FIG. 8 illustrates an exemplary flow chart of procedures that facilitate decomposing an application in accordance with an aspect of the innovation.

FIG. 9 illustrates an exemplary flow chart of procedures that facilitate identifying threats in accordance with an aspect of the innovation.

FIG. 10 illustrates an exemplary attack tree in accordance with an aspect of the innovation.

FIG. 11 illustrates an exemplary flow chart of procedures that facilitate identification of vulnerabilities in accordance with an aspect of the innovation.

FIG. 12 illustrates an exemplary overall security engineering system with respect to the application life cycle and in accordance with an aspect of the novel innovation.

FIG. 13 illustrates an architecture including an artificial intelligence-based component that can automate functionality in accordance with an aspect of the novel innovation.

FIG. 14 illustrates a block diagram of a computer operable to execute the disclosed architecture.

FIG. 15 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

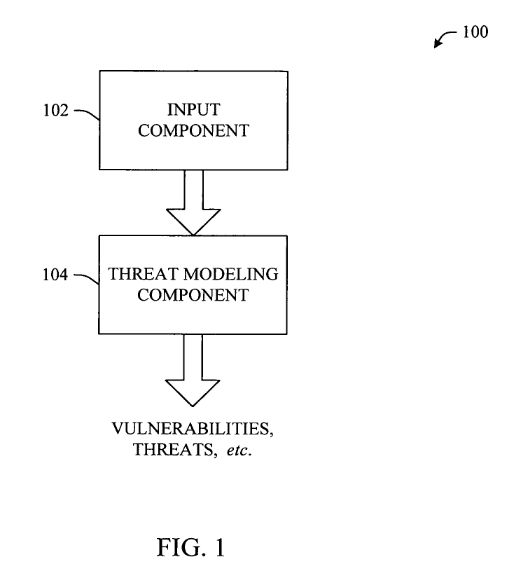

Referring initially to the drawings, FIG. 1 illustrates a security engineering system 100 in accordance with an aspect of the innovation. Generally, the system 100 can include an input component 102 and a threat modeling component 104. The input component 102 can accept an input including, but not limited to, use case scenarios, data flows, data schemas, deployment diagrams, etc. Accordingly, the threat modeling component can identify vulnerabilities, threats, etc. from the input. This generated output can facilitate proactive security modeling throughout the application life cycle.

As stated previously, conventionally, security is most often treated at the end of the application life cycle where the problem cannot be easily fixed. To this end, the novel system 100 can facilitate proactive security engineering and modeling throughout the application life cycle. This proactive security engineering and modeling can help identify threats and vulnerabilities throughout the application life cycle. In other words, the novel innovation can facilitate security integration in the application life cycle by identifying a set of proven security focused activities. These security focused activities can be integrated into the application life cycle thereby enhancing ability to meet security objectives.

The subject system 100 can provide a stable backdrop that facilitates methodical categorization and grouping of security issues with respect to the application life cycle. It is a novel feature of the innovation to provide an information model that is stackable and extensible. For example, the innovation permits adding to the base list of categories.

In accordance with disparate aspects, the subject system 100 can be employed in connection with any category associated with the application life cycle including, but not limited to patches and updates, services, protocols, accounts, files and directories, shares, ports, registry, auditing and logging, etc. It is to be understood that these categories reflect a deep security analysis across server security to identify key categories that represent vulnerabilities.

As stated above, designing for application security is oftentimes very random and does not always produce effective results. Furthermore, threat modeling is frequently too difficult for the typical software practitioner. The subject system 100 can address each of these scenarios. More particularly, the subject system 100 can provide for a lightweight, action-oriented, document-centric approach to threat modeling that can produce repeatable results. Aspects of the innovation can integrate the novel functionality of the system 100 into Visual Studio-brand environments.

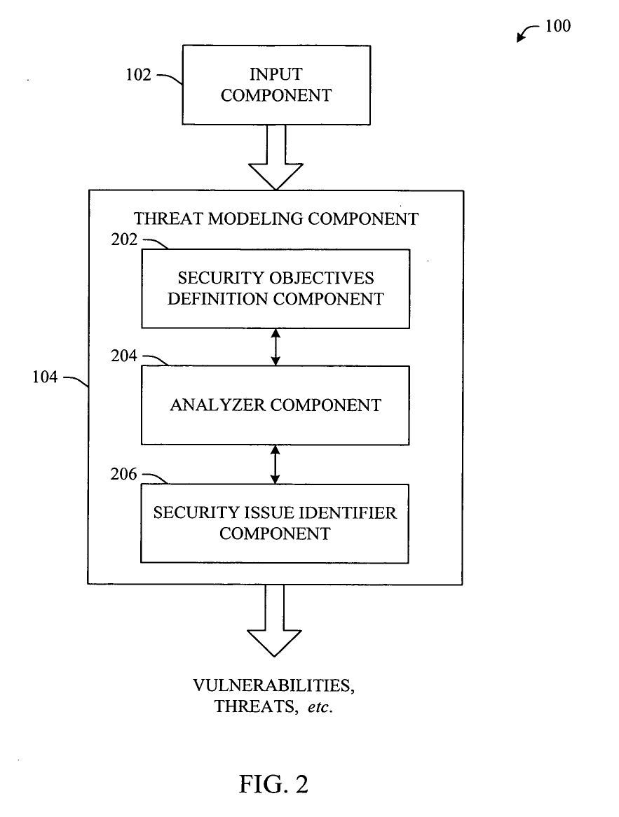

Turning now to FIG. 2, an alternative block diagram of exemplary system 100 is shown. As illustrated in FIG. 2, threat modeling component 104 can include a security objectives definition component 202, an analyzer component 204 and a security issue identifier component 206. Novel functionality of each of these components will be described in greater detail with reference to the figures that follow.

In operation, the security objectives definition component 202 can facilitate identifying security goals. The analyzer component 202 can facilitate establishment of an application overview as well as an application decomposition. The security issue identifier component 204 can facilitate identifying threats and vulnerabilities with respect to the application life cycle based at least in part upon the goal(s).

Input component 102 can accept a number of criterions that can be supplied to the threat modeling component 104. Following is a list of exemplary inputs to the threat modeling component 104. It is to be appreciated that this list of inputs is not to be considered exhaustive and that other inputs associated to an application life cycle can be applied without departing from the spirit and scope of this disclosure and claims appended hereto.

Use cases and usage scenarios;

Data flows;

Data schemas; and

Deployment diagrams.

Although all of the aforementioned inputs are useful, it is to be understood that none of them are essential to the novel functionality described herein. All in all, the novel functionality of the innovation can be employed based upon knowledge of a subject application's primary function and architecture. In response to the input, the novel system 100 can generate a threat model. Accordingly, in one aspect, the threat model can include a list of threats and/or a list of vulnerabilities.

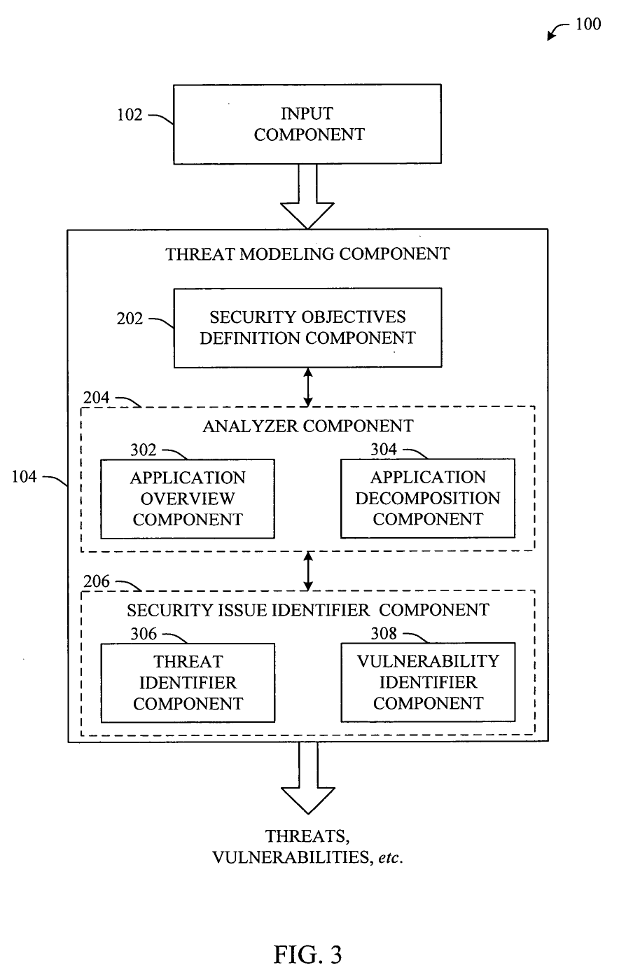

FIG. 3 illustrates an alternative architectural component diagram of system 100 in accordance with an aspect of the innovation. More particularly, threat modeling component 104 can include a security objectives definition component 202, an analyzer component 204 (that includes an application overview component 302 and an application decomposition component 304) and a security issue identifier component 204 (that includes a threat identifier component 306 and a vulnerability identifier component 308).

Following is a detailed discussion of an iterative threat modeling process in accordance with an aspect of the innovation. It will be appreciated that the novel methodology described infra can be effected via the novel threat modeling component 104 and associated sub-components shown in FIG. 3. While a specific threat modeling process is described in detail infra, it is to be understood that other aspects of the novel functionality can include a subset of the process described as well as additional steps not shown. These alternative aspects are to be included within the scope of the innovation and claims appended hereto.

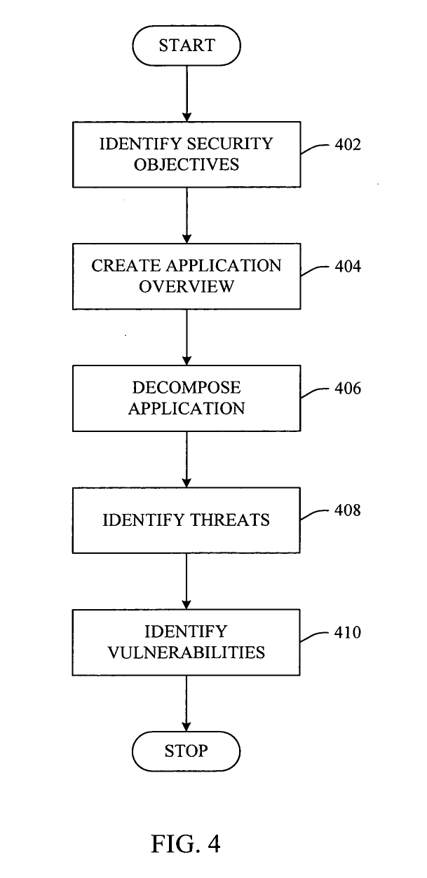

FIG. 4 illustrates a methodology of threat modeling in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

More particularly, FIG. 4 illustrates an exemplary five step iterative threat modeling process in accordance with an aspect of the innovation. As shown, at 402, security objectives (e.g., goals) can be identified. This act can include identifying clear objectives that can assist in focusing the threat modeling activity. As well, these goals can assist in determining determine how much effort (e.g., budget) to use on subsequent acts.

At 404, an application overview can be created. This overview can assist in itemizing the application's particularly important characteristics. Moreover, the overview can assist in identifying relevant threats as set forth in an act that follows.

Next at 406, the application can be decomposed in order to gain a more detailed understanding of the mechanics of the application. This decomposition can facilitate identification of more relevant and more detailed threats. In other words, because a more detailed understanding of the application can be established, it can be easier to identify threats.

At 408, threats to the application can be identified. As described above, details of the application overview (e.g., act 404) and information gained as a result of the decomposition (e.g., act 406) can be employed to identify threats relevant to the particular application scenario and context (e.g., act 402).

Finally, vulnerabilities can be identified at 410. More particularly, a review of the layers of the application can be conducted to identify weaknesses related to the threats identified at 408. As will be understood following a more detailed review of the methodologies that follow, these vulnerability categories can be employed to assist in focusing on those areas where mistakes are most often made.

It will be understood that the methodology described in FIG. 4 facilitates adding progressively more detail to the threat model as the application development life cycle unfolds. As well, the methodology of FIG. 4 assists in discovery of more details about the application design. Because key resources identified in threat modeling can also likely to be key resources from a performance and functionality perspective, it is possible to revisit and adjust the model as needs are balanced. It will be appreciated that this is one novel and valuable outcome of the process.

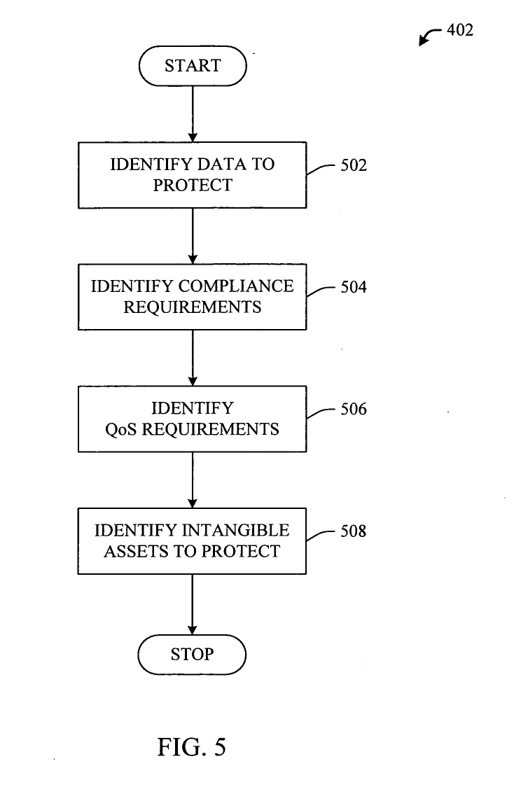

FIG. 5 illustrates a process flow diagram of a methodology 402 of identifying security objectives in accordance with an aspect of the innovation. Security objectives can be goals and/or constraints related to the confidentiality, integrity, and availability of the application and data associated therewith. Each of these factors will be described in greater detail below.

Confidentiality can include protecting against unauthorized information disclosure. Similarly, integrity can include preventing unauthorized information changes. In other words, each of these two factors is directed to any unauthorized information access and/or disclosure. Availability can refer to the ability to provide required services even while under attack. It will be understood that all three of these factors are most often equally important with respect to application security.

It is further to be understood that security-specific objectives (e.g., constraints) are a subset of project objectives and can be employed to guide threat modeling efforts. In one aspect, it can be particularly helpful to think of security-specific objectives by posing the following question, “What do you not want to happen?” For example, an attacker must not be able to steal user credentials.

By identifying key security objectives, it will be possible to determine where to focus efforts and likewise expend budget. Identifying security objectives also helps to understand the goals of potential attackers and concentrate on those areas of the application that may require closer attention. By way of example, if customer account details are identified as sensitive data that needs protecting, it will be possible to examine how securely the data is stored and how access to the data is controlled and audited.

With reference again to the flow diagram 402, in order to determine security objectives the following acts can be employed. At 502, data to protect can be identified by considering the question, “What client data do you need to protect?” For example, does the application use user accounts and passwords, customer account details including personalization information, financial history and transaction records, customer credit card numbers, bank details, or travel itineraries? In each of the aforementioned questions, confidential data is identified.

At 504, compliance requirement can be identified. More particularly, if present, compliance requirements can include security policies, privacy laws, regulations, and/or standards. Furthermore, quality of service (QoS) requirements can be identified. For instance, QoS requirements can include availability and performance requirements. Intangible assets can be identified at 508. These intangible items can include a company's reputation, trade secrets, and intellectual property.

While specific examples have been given herein, it is to be understood that other factors can contribute to the establishment of security objectives. These additional aspects and factors are to be included within the scope of this disclosure and claims appended hereto.

Follow are some examples of security objectives in accordance with the novel functionality described herein. A first objective or goal is directed to the prevention of attackers from obtaining sensitive customer data, including passwords and profile information. Another objective can be directed to meeting service-level agreements (SLAs) for application availability. Still another exemplary security objective is directed to protecting the company's online business credibility.

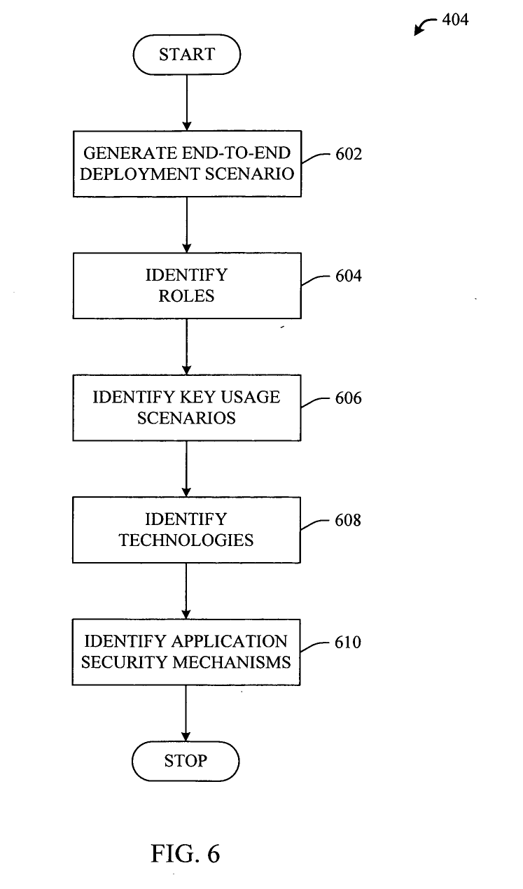

FIG. 6 illustrates an exemplary process flow diagram of a methodology 404 of creating an application overview in accordance with an aspect of the innovation. In this process and in accordance with a web application aspect, an outline of the functionality of the web application can be generated. One goal is to identify the application's key functionality, characteristics, and clients. It will be understood that this information will assist in the identification of relevant threats as set forth in 408 supra.

It will be understood that threat modeling is an iterative process. In other words, the acts set forth can be revisited in order to supplement and/or append data/information. To this end, progress should not be impaired by any of the acts described herein. In other words, it can be particularly helpful to identify as much detail as possible and then add more detail as the design evolves. By way of example, if in the middle of the design and not yet tackled physical deployment, it is still possible to perform this process, although with less data.

Referring again to FIG. 6, a five step process of creating an application overview is shown in accordance with an aspect of the innovation. At 602, an end-to-end deployment scenario can be generated. Roles can be identified at 604 and key usage scenarios at 606. Technologies can be identified at 608 and finally, at 610, application security mechanisms can be identified.

Each of these acts in the process of creating an application overview 404 will be described in greater detail as follows. As stated above, at 602, an end-to-end deployment scenario can be generated. Accordingly, a whiteboard, tablet PC, or the like can be employed to draw the end-to-end deployment scenario. First, a rough diagram can be drawn that describes the composition and structure of the application, its subsystems, and its deployment characteristics.

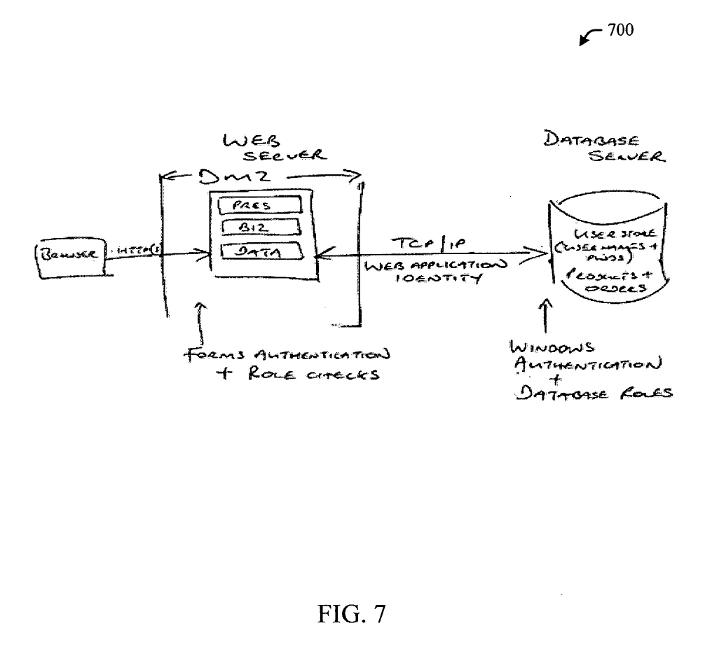

An exemplary rough end-to-end diagram 700 is shown in FIG. 7. As illustrated in FIG. 7, the rough diagram 700 can include details about the authentication, authorization, and communication mechanisms as the details become available. It will be appreciated that, oftentimes, not all of the details will be available early in the design process.

With continued reference to the application architecture illustrated in FIG. 7, the deployment diagram 700 should generally include an end-to-end deployment topology. In one aspect, this topology can show the layout of the servers and indicate intranet, extranet, or Internet access. In operation, it is often advantageous to start with logical network topologies, and then refine to show physical topologies as details become available. It is to be understood that threats can be added or removed depending on a choice of specific physical topologies.

The deployment diagram 700 can also include an illustration of logical layers. Continuing with the example of FIG. 7, these layers can show where the presentation layer, business layer, and data access layers reside. This layer illustration can be refined to include physical server boundaries as they become available. Key components can be illustrated within each logical layer. As with other aspects of the diagram, these key components can be refined to include actual process and component boundaries as they become available.

Additionally, any important and/or key services can be identified and illustrated as processes on the diagram 700. Similarly, communication ports and protocols can be illustrated. For example, the diagram can illustrate which servers, components, and services communicate with each other and how the communication is effected. Additionally, specifics of inbound and outbound information packages can be shown.

With continued reference to the diagram 700, main identities used in connection with the application and any relevant service accounts can be identified. External dependencies of the application on external systems can also be shown. It will be appreciated that this information can be useful to assist in the identification of vulnerabilities that can arise if any assumptions made about the external systems are false or if the external systems change in any way. It will further be appreciated that, as the design evolves, the threat model diagram should be revisited to add more detail as it becomes available. For example, all of the components might not be known initially. The application can be subdivided as necessary to get enough detail to locate threats.

With reference again to the process flow 404 illustrated in FIG. 6, at 604, roles can be identified. In other words, identification can be made as to who can perform which action, or groups of actions, within an application. In one example, this determination can be based upon user privileges. In another example, the role determination can be based upon data type, importance, confidentiality, etc. These roles can determine who can read data, update data, change data, export data, etc. This role identification can be employed to determine both what is supposed to happen and what is not supposed to happen.

At 606, key usage scenarios can be identified to delineate particularly important and/or useful features of the application. The application use cases can be employed to derive this information. In one aspect, this act can be employed to identify the dominant application functionality and usage, and to capture create, read, update, and delete aspects.

Key features are often explained in the context of use cases. They can assist in an understanding of how the application is intended to be used and how it can be misused. Use cases help identify data flows and provide focus when identifying threats later in the modeling process. In operation, a user can start by identifying the main use cases that exercise the predominant create, read, update, and delete functionality of the application. For example, a self-service, employee human resources application might include the following use cases:

Employee views financial data;

Employee updates personal data;

Manager views employee details; and

Manager deletes employee records.

In these cases, it can be possible to determine possibilities of the business rules being misused. For example, consider a user trying to modify personal details of another user. It will often be important to consider several use cases that occur simultaneously to perform a complete analysis. Furthermore, it can also be helpful to identify what scenarios are out of scope and to employ the key scenarios to constrain the discussion. For example, a determination can be made that that operational practices, such as backup and restore, are out of scope for the initial threat modeling exercise.

Technologies can be identified at 608. In other words, information relating to key features of the software and technologies can include identification of:

Operating systems;

Web server software;

Database server software;

Technologies used in the presentation, business, and data access layers; and

Development languages.

Identifying technologies can assist in focusing on technology-specific threats later in the threat modeling activity. Technology identification can also help to determine the correct and most appropriate mitigation techniques.

At 610, application security mechanisms can be identified. In doing so, in one aspect, an identification can be made to identify any key points known about the following:

Input and data validation;

Authentication;

Authorization;

Configuration management;

Sensitive data;

Session management;

Cryptography;

Parameter manipulation;

Exception management; and

Auditing and logging.

One result of this effort is the identification of interesting details and the ability to add detail where necessary, or to identify areas where additional information is needed.

For example, in operation, it might be known as to how the application is authenticated by the database or how your users are authorized. As well, other areas where the application performs authentication and authorization can be known. Additionally, certain details about how input validation is to be performed can be known. These areas can be highlighted along with other key elements of your application security mechanisms.

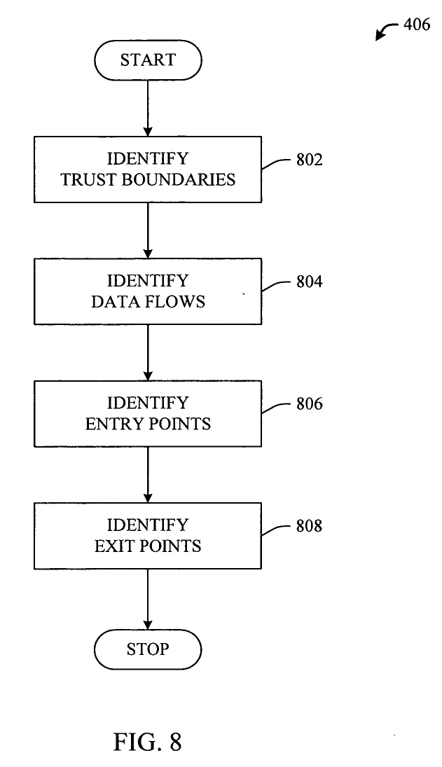

FIG. 8 illustrates a process flow diagram 406 of decomposing an application in accordance with an aspect of the innovation. In this methodology 406, the application can be broken down to identify trust boundaries (802), data flows (804), entry points (806), and exit points (808). It will be appreciated that the more that is known about the mechanics of the application, the easier it can be to uncover threats and discover vulnerabilities.

At 802 trust boundaries can be identified which can help focus analysis on areas of concern. Trust boundaries can indicate where trust levels change. It will be appreciated that trust can be viewed in the perspective of confidentiality and integrity. For example, a change in access control levels in the application where a specific role or privilege level is required to access a resource or operation could be viewed as a change in trust level. Another example would be at an entry point in the application where the data passed to the entry point is not fully trusted.

In operation, and in order to assist in identifying trust boundaries, in one example, it can useful to start by identifying the outer system boundaries. For example, the application can write to files on server X, it can make calls to the database on server Y, and it can call Web service Z. This defines the system boundary.

The identification of access control points can further assist in identification of trust boundaries. In other words, it can helpful to identify access control points or the key places where access requires additional privileges or role membership. For example, a particular page might be restricted to managers. The page can require authenticated access and can also require that the caller is a member of a particular role.

Additional assistance in the identification of trust boundaries can be gained from a data flow perspective. For each subsystem, it can be helpful to consider whether the upstream data flow or user input is trusted, and if it is not, to consider how the data flow and input can be authenticated and authorized. Knowing which entry points exist between trust boundaries allows focus of threat identification on these key entry points. For example, it can be likely to have to perform more validation on data passed through an entry point at a trust boundary.

A perimeter firewall is an example of a trust boundary. In most instances, the firewall is likely to be the first trust boundary. It will be appreciated that a firewall can be employed to move qualified information from the untrusted Internet to your trusted data center.

Another example of a trust boundary can refer to the boundary between the Web server and database server. The database may or may not be included in the application's trust boundary. Oftentimes the Web servers act as a second firewall to the databases. It will be understood that this can significantly limit network access to the databases and thereby reduces the attack surface.

Yet another example of a trust boundary is the entry point into a business component that exposes privileged data (e.g., data that should be available to only particular users). In this case, it can be useful to perform an access check to ensure that only the appropriate callers are allowed access. Accordingly, this is a trust boundary. Similarly, the boundary between the application and a third-party service can also be considered a trust boundary and can therefore be identified at 802.

At 804, the data flows can be identified to assist in the threat modeling according to an aspect. In this act, the application's data input can be traced through the application from entry to exit. This tracing can be useful to understand how the application interacts with external systems and clients and how internal components interact. It is particularly useful to examine data flow across trust boundaries and how that data is validated at the trust boundary entry point. Moreover, it is useful to examine sensitive data items and how these flow through the system, e.g., where they are passed over a network, and where they are persisted.

In operation, one approach is to start at the highest level and then deconstruct the application by analyzing the data flow between individual subsystems. For example, start by analyzing the data flow between the Web application, middle tier servers, and database server then consider page-to-page and component-to-component data flows.

Turning now to a discussion of the identification of entry points at 806, it is to be understood that the entry points of the application can also serve as entry points for attacks. Entry points can include the front-end Web application listening for HTTP requests. This entry point can be exposed to clients.

Other entry points, such as internal entry points exposed by subcomponents across the layers of the application, can exist only to support internal communication with other components. It can be useful to know where these are and what types of input they receive in case an attacker manages to bypass the front door of the application and directly attacks an internal entry point. Additional levels of checking provides defense in depth but may be costly in terms of money and performance. In operation, it can be helpful to consider the trust levels required to access an entry point and the type of functionality exposed by the entry point. Early in the threat modeling activity, attention can be focused on entry points that expose privileged functionality, such as administration interfaces.

Exit points can be identified at 808 whereby an identification of the points where the application sends data to the client or to external systems can be effected. The exit points can be prioritized where your application writes data that includes client input or includes data from untrusted sources, such as shared databases.

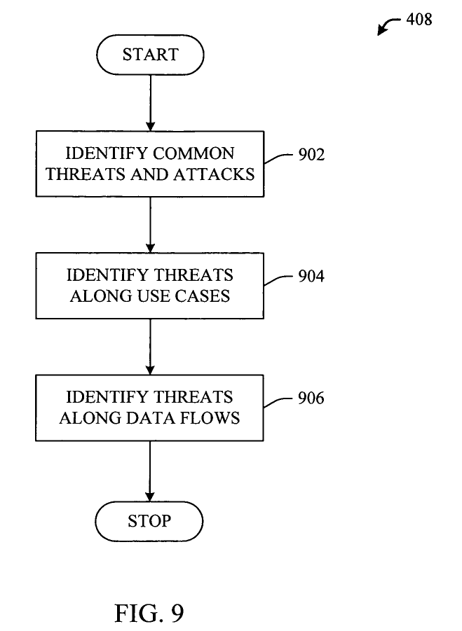

Referring now to FIG. 9, in accordance with the methodology 408, threats can be identified utilizing the information gathered in acts 402-406. Generally, threats and attacks can be identified that might affect the application and compromise security objectives. These threats can be viewed as bad effects that could happen to the application. Any method can be employed to identify the threats.

In one example, members of the development and test teams can be brought together to conduct an informed brainstorming session. A whiteboard or tablet-PC can be employed to identify potential threats. In this aspect, the team can consist of application architects, security professionals, developers, testers, and system administrators.

Two exemplary approaches will be described below. While these approaches are specific in nature, it is to be understood that these approaches are included to provide perspective to the innovation and are not to be considered exhaustive in any way. It is further to be appreciated that other approaches exist and are to be included within the scope of this innovation and claims appended hereto.

In a first exemplary approach, the identification of threats 408 can employ a predefined list of common threats grouped by application vulnerability categories. This threat list can be applied to the subject application architecture. While doing this, the information gathered, as described above, can be employed. For example, the identified scenarios to review data flows can be used, paying particular attention to entry points and where trust boundaries are crossed. It will be appreciated that some threats can immediately be eliminated because they do not apply to the application and its use cases.

Another exemplary approach can employ an automated question-driven information gathering approach. It will be appreciated that a question-driven approach can help identify relevant threats and attacks while utilizing preprogrammed expertise not necessarily possessed by the typical user.

It is to be understood that a user can group threats into categories. One exemplary model is “STRIDE”, derived from an acronym for the following six threat categories:

Spoofing identity. An example of identity spoofing is illegally accessing and then using another user's authentication information, such as username and password.

Tampering with data. Data tampering involves the malicious modification of data. Examples include unauthorized changes made to persistent data, such as that held in a database, and the alteration of data as it flows between two computers over an open network, such as the Internet.

Repudiation. Repudiation threats are associated with users who deny performing an action without other parties having any way to prove otherwise—for example, a user performs an illegal operation in a system that lacks the ability to trace the prohibited operations. Nonrepudiation refers to the ability of a system to counter repudiation threats. For example, a user who purchases an item might have to sign for the item upon receipt. The vendor can then use the signed receipt as evidence that the user did receive the package.

Information disclosure. Information disclosure threats involve the exposure of information to individuals who are not supposed to have access to it—for example, the ability of users to read a file that they were not granted access to, or the ability of an intruder to read data in transit between two computers.

Denial of service. Denial of service (DoS) attacks deny service to valid users—for example, by making a Web server temporarily unavailable or unusable. You must protect against certain types of DoS threats simply to improve system availability and reliability.

Elevation of privilege. In this type of threat, an unprivileged user gains privileged access and thereby has sufficient access to compromise or destroy the entire system. Elevation of privilege threats include those situations in which an attacker has effectively penetrated all system defenses and become part of the trusted system itself, a dangerous situation indeed.

The STRIDE categorization includes broad categories of threats, such as spoofing, tampering, repudiation, information disclosure, and denial of service. The novel system/methodology can use the STRIDE model to ask questions related to each aspect of the architecture and design of the application. This is a goal-based approach, where the goals of an attacker are considered. For example, could an attacker spoof an identity to access the server or Web application? Could someone tamper with data over the network or in a data store? Is sensitive information disclosed when a user reports an error message or log an event? Could someone deny service?

While identifying threats, it can be helpful to examine the application tier by tier, layer by layer, and feature by feature. By focusing on vulnerability categories, a user can focus on areas where security mistakes are most frequently made. The threats identified at this stage do not necessarily indicate vulnerabilities. Potential threats and the actions that an attacker might try to use to exploit the application can be identified.

Referring again to FIG. 9, at 902 common threats and attacks can be identified. There are a number of common threats and attacks that rely on common vulnerabilities. As a starting point, a checklist or an application security frame (e.g., Web application security frame) can be employed to assist in the identification. The security frame can help identify threats and attacks relevant to your application.

With respect to a specific Web application security frame, the following vulnerability categories identify specific security issues across many Web applications. As described supra, because typical users lack expertise, this novel security frame can incorporate information based upon examination and analysis of the top security issues across many Web applications. In accordance therewith, following is a set of key information gathering questions with respect to each category.

Authentication can be reviewed by posing the following:

How could an attacker spoof identity?

How could an attacker gain access to the credential store?

How could an attacker mount a dictionary attack?

How are your user's credentials stored and what password policies are enforced?

How can an attacker modify, intercept, or bypass user credential reset mechanism?

Authorization can be reviewed by posing the following:

How could an attacker influence authorization checks to gain access to privileged operations?

How could an attacker elevate privileges?

Input and data validation can be reviewed by posing the following:

How could an attacker inject SQL commands?

How could an attacker perform a cross-site scripting attack?

How could an attacker bypass input validation?

How could an attacker send invalid input to influence security logic on the server?

How could an attacker send malformed input to crash the application?

Configuration management can be reviewed by posing the following:

How could an attacker gain access to administration functionality?

How could an attacker gain access to your application's configuration data?

Sensitive data can be reviewed by posing the following:

Where and how does your application store sensitive data?

When and where is sensitive data passed across a network?

How could an attacker view sensitive data?

How could an attacker manipulate sensitive data?

Session management can be reviewed by asking the following:

Do you use a custom encryption algorithm, and do you trust the algorithm?

How could an attacker hijack a session?

How could an attacker view or manipulate another user's session state?

Cryptography can be reviewed by posing the following:

What would it take for an attacker to crack your encryption?

How could an attacker obtain access to encryption keys?

Which cryptographic standards are you using?

What, if any, are the known attacks on these standards?

Are you creating your own cryptography?

How does your deployment topology potentially impact your choice of encryption methods?

Parameter manipulation can be reviewed by posing the following:

How could an attacker manipulate parameters to influence security logic on the server?

How could an attacker manipulate sensitive parameter data?

Exception management can be reviewed by posing the following:

How could an attacker crash the application?

How could an attacker gain useful exception details?

Auditing and logging can be reviewed by posing the following:

How could an attacker cover his or her tracks?

How can you prove that an attacker (or legitimate user) performed specific actions?

With reference again to FIG. 9, at 904, threats along use cases can be identified. In accordance with this act, each of the application's key use cases that were identified earlier can be examined. As well, ways in which a user could maliciously or unintentionally coerce the application into performing an unauthorized operation or into disclosing sensitive or private data can be analyzed.

In furtherance of the examination, following are an exemplary list of questions that can be posed:

How can a client inject malicious input here?

Is data being written out based on user input or on unvalidated user input?

How could an attacker manipulate session data?

How could an attacker obtain sensitive data as it is passed over the network?

How could an attacker bypass your authorization checks?

Next, threats along data flows can be identified at 906. In order to identify threats along data flows a review of the key use cases and scenarios can be effected along with an analysis of the data flows. Additionally, the data flow between individual components in the architecture can be analyzed. It will be appreciated that data flow across trust boundaries can be particularly important. It is a prudent practice for any piece of code to assume that any data from outside the code's trust boundary is malicious. To this end, the code should perform thorough validation of the data.

In identifying threats associated with data flows, the following questions can be posed:

How does data flow from the front end to the back end of your application?

Which components call which components?

What does valid data look like?

Where is validation performed?

How is the data constrained?

How is data validated against expected length, range, format, and type?

What sensitive data is passed between components and across networks, and how is that data secured while in transit?

It is to be appreciated that existing documentation should be employed if available. For example, data flow diagrams (DFDs) and Unified Modeling Language (UML) sequence diagrams can help to analyze application and identify data flows.

In other aspects, additional threats can be explored using threat/attack trees. In most cases, the aforementioned activities can assist to identify the more obvious and pervasive security issues. Attack trees and attack patterns are the primary tools that many security professionals use and can be employed to identify additional threats. More particularly, attack trees and attack patterns enable analysis of threats in greater depth, going beyond what is already know to identify other threat possibilities.

The categorized lists of known threats can reveal the common, known threats. Additional approaches, such as using threat/attack trees and attack patterns, can help identify other potential threats. An attack tree is a way of identifying and documenting the potential attacks on the system in a structured and hierarchical manner. The tree structure can give a detailed picture of various attacks that an attacker can use to compromise the system.

By creating an attack tree, a user can create a reusable representation of security issues that can help to focus threat and mitigation efforts. A test team can use the trees to create test plans that validate security design. Architects or developer leads can use the trees to evaluate the security cost of alternative approaches. Developers can use the trees to make informed coding decisions during implementation. Attack patterns are a formalized approach to capturing attack information in an enterprise. These patterns can help identify common attack techniques.

When creating an attack tree, it can be useful to assume the role of an attacker. For example, consider what must be done to launch a successful attack and identify goals and sub-goals of the attack. A hierarchical diagram can be employed to represent the attack tree. Alternatively, a simple outline can be utilized. It is particularly important to construct something that portrays the attack profile of the application. Subsequently, security risks can be evaluated and appropriate countermeasures can be used to mitigate them, such as correcting a design approach, hardening a configuration setting, and other solutions.

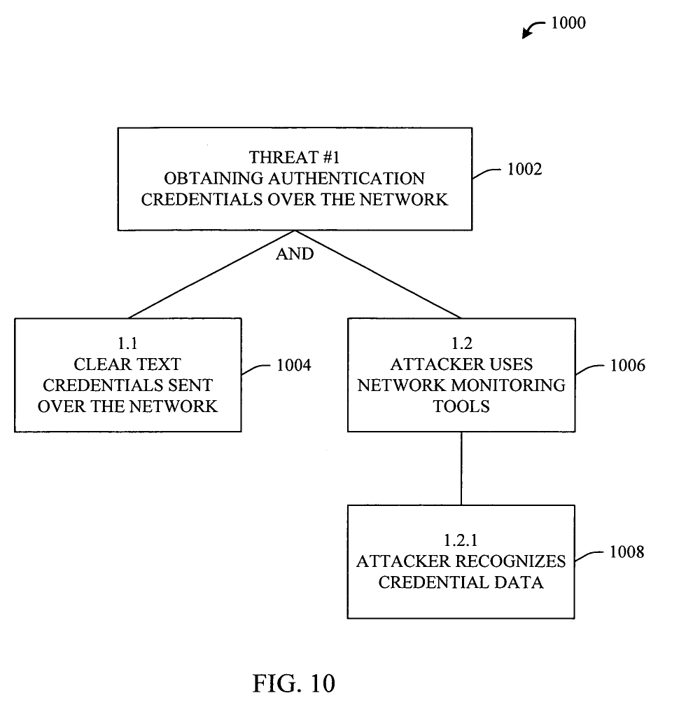

FIG. 10 illustrates a simple example of an attack tree in accordance with an aspect of the innovation. As illustrated, a user can start building an attack tree by creating root node(s) (1002) that represent the goals of the attacker. Next, leaf nodes (1004-1008) can be added, which are the attack methodologies that represent unique attacks.

As illustrated in FIG. 10, the leaf nodes can be labeled with AND and OR labels. For example, in FIG. 10, both 1.1 and 1.2 must occur for the threat to result in an attack. Attack trees like the one in this example can have a tendency to become complex quickly. Additionally, they can also be time-consuming to create. An alternative approach is to structure your attack tree using an outline, such as the following.

1. Goal One

1.1 Sub-goal One

1.2 Sub-goal Two

2. Goal Two

2.1 Sub-goal One

2.2 Sub-goal Two

In addition to goals and sub-goals, attack trees can include methodologies and required conditions. The following is a more complete example of the outline approach with respect to the example of FIG. 10.

Threat #1—Attacker Obtains Authentication Credentials by Monitoring the Network

1.1 Clear text credentials sent over the network AND

1.2 Attacker uses network-monitoring tools

1.2.1 Attacker recognizes credential data

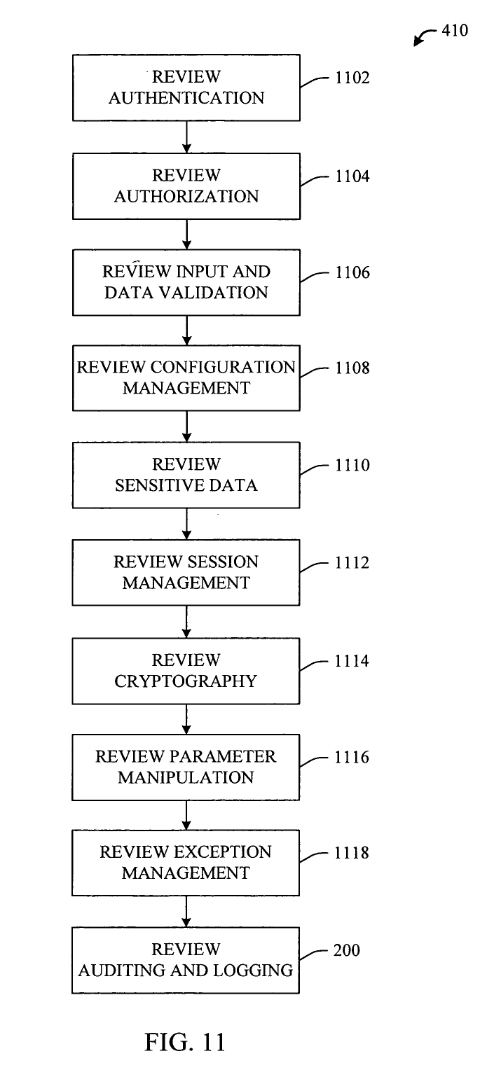

Turning now to FIG. 11, a process flow diagram 410 that facilitates identifying vulnerabilities in accordance with an aspect of the innovation is shown. In accordance with this process 410, a user can review a Web application security frame and explicitly look for vulnerabilities. As described with reference to previous process flows, it is to be understood that the sample questions presented in this section can assist in the identification of vulnerabilities, not threats. Moreover, it is to be understood that a particularly useful way of proceeding is to examine the application layer by layer, considering each of the vulnerability categories in each layer.

At 1102, authentication can be reviewed. In one aspect, the following questions can be posed:

Are user names and passwords sent in clear text over an unprotected channel?

Is any ad hoc cryptography used for sensitive information?

Are credentials stored? If they are stored, how are they stored and protected?

Do you enforce strong passwords? What other password policies are enforced?

How are credentials verified?

How is the authenticated user identified after the initial logon?

In the aspect, authentication can be reviewed by looking for these common vulnerabilities:

Passing authentication credentials or authentication cookies over unencrypted network links, which can lead to credential capture or session hijacking;

Using weak password and account policies, which can lead to unauthorized access; and

Mixing personalization with authentication.

At 1104, authorization can be reviewed. In one aspect, the following questions can be posed:

What access controls are used at the entry points of the application?

Does your application use roles? If it uses roles, are they sufficiently granular for access control and auditing purposes?

Does your authorization code fail securely and grant access only upon successful confirmation of credentials?

Do you restrict access to system resources?

Do you restrict database access?

How is authorization enforced at the database?

In the aspect, authorization can be reviewed by looking for these common vulnerabilities:

Using over-privileged roles and accounts

Failing to provide sufficient role granularity

Failing to restrict system resources to particular application identities

At 1106, input and data validation vulnerabilities can be reviewed. In one aspect, the following questions can be posed:

Is all input data validated?

Do you validate for length, range, format, and type?

Do you rely on client-side validation?

Could an attacker inject commands or malicious data into the application?

Do you trust data you write out to Web pages, or do you need to HTML-encode it to help prevent cross-site scripting attacks?

Do you validate input before using it in SQL statements to help prevent SQL injection?

Is data validated at the recipient entry point as it is passed between separate trust boundaries?

Can you trust data in the database?

Do you accept input file names, URLs, or user names? Have you addressed canonicalization issues?

In the aspect, input validation can be reviewed by looking for these common vulnerabilities:

Relying exclusively on client-side validation;

Using a deny approach instead of allow for filtering input;

Writing data you did not validate out to Web pages;

Using input you did not validate to generate SQL queries;

Using insecure data access coding techniques, which can increase the threat posed by SQL injection; and

Using input file names, URLs, or user names for security decisions.

At 1108, configuration management vulnerabilities can be reviewed. In one aspect, the following questions can be posed:

How do you protect remote administration interfaces?

Do you protect configuration stores?

Do you encrypt sensitive configuration data?

Do you separate administrator privileges?

Do you use least privileged process and service accounts?

In the aspect, configuration management can be reviewed by looking for these common vulnerabilities:

Storing configuration secrets, such as connection strings and service account credentials, in clear text;

Failing to protect the configuration management aspects of your application, including administration interfaces;

Using over-privileged process accounts and service accounts.

At 1110, sensitive data vulnerabilities can be reviewed. In one aspect, the following questions can be posed:

Do you store secrets in persistent stores?

How do you store sensitive data?

Do you store secrets in memory?

Do you pass sensitive data over the network?

Do you log sensitive data?

In the aspect, sensitive data can be reviewed by looking for these common vulnerabilities:

Storing secrets when you do not need to store them;

Storing secrets in code;

Storing secrets in clear text; and

Passing sensitive data in clear text over networks.

At 1112, session management vulnerabilities can be reviewed. In one aspect, the following questions can be posed:

How are session cookies generated?

How are session identifiers exchanged?

How is session state protected as it crosses the network?

How is session state protected to prevent session hijacking?

How is the session state store protected?

Do you restrict session lifetime?

How does the application authenticate with the session store?

Are credentials passed over the network and are they maintained by the application? If they are, how are they protected?

In the aspect, session management can be reviewed by looking for these common vulnerabilities:

Passing session identifiers over unencrypted channels;

Prolonged session lifetime;

Insecure session state stores; and

Session identifiers in query strings.

At 1114, cryptographic vulnerabilities can be reviewed. In one aspect, the following questions can be posed:

What algorithms and cryptographic techniques are used?

Do you use custom encryption algorithms?

Why do you use particular algorithms?

How long are encryption keys, and how are they protected?

How often are keys recycled?

How are encryption keys distributed?

In the aspect, cryptography can be reviewed by looking for these common vulnerabilities:

Using custom cryptography

Using the wrong algorithm or a key size that is too small

Failing to protect encryption keys

Using the same key for a prolonged period of time

At 1116, parameter manipulation vulnerabilities can be reviewed. In one aspect, the following questions can be posed:

Do you validate all input parameters?

Do you validate all parameters in form fields, view state, cookie data, and HTTP headers?

Do you pass sensitive data in parameters?

Does the application detect tampered parameters?

In the aspect, parameter manipulation can be reviewed by looking for these common vulnerabilities:

Failing to validate all input parameters. This makes your application susceptible to denial of service attacks and code injection attacks, including SQL injection and XSS.

Including sensitive data in unencrypted cookies. Cookie data can be changed at the client or it can be captured and changed as it is passed over the network.

Including sensitive data in query strings and form fields. Query strings and form fields are easily changed on the client.

Trusting HTTP header information. This information is easily changed on the client.

At 1118, exception management vulnerabilities can be reviewed. In one aspect, the following questions can be posed:

How does the application handle error conditions?

Are exceptions ever allowed to propagate back to the client?

What type of data is included in exception messages?

Do you reveal too much information to the client?

Where do you log exception details? Are the log files secure?

In the aspect, exception management can be reviewed by looking for these common vulnerabilities:

Failing to validate all input parameters; and

Revealing too much information to the client.

At 1120, auditing and logging vulnerabilities can be reviewed. In one aspect, the following questions can be posed:

Have you identified key activities to audit?

Does your application audit activity across all layers and servers?

How are log files protected?

In the aspect, auditing and logging can be reviewed by looking for these common vulnerabilities:

Failing to audit failed logons

Failing to protect audit files

Failing to audit across application layers and servers

As described in detail supra, security can be integrated into the application life cycle. Although security is a rising concern for the industry and, as well is the least regulated and most random to application development, most users do not know where to start, how to proceed, and when enough is enough with respect to addressing security in application development. The subject novel innovation provides a system and methodology that can address these and other concerns.

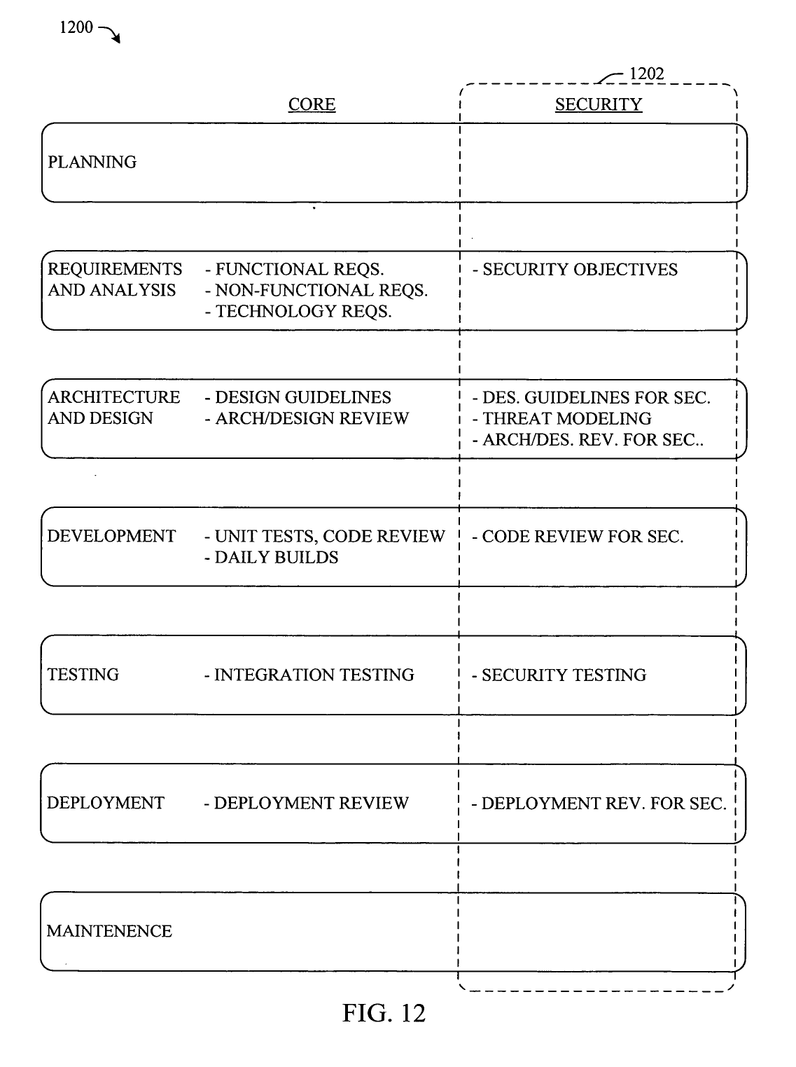

With reference to FIG. 12, the novel security integration in the application life cycle 1200 can identify a set of proven security-focused activities 1202 and can integrate them into the application life cycle 1200. It will be understood that the integration of these activities 1202 can improve a user's ability to meet security objectives.

Moreover, the subject novel innovation facilitates the ability to bake security into the application life cycle. In doing so, security focus can be added to the following common activities:

Design guidelines for security;

Arch and design review for security;

Code review for security;

Deployment review for security;

Add threat modeling up front to identify security objectives and shape application design.

Use scenario-based and type (web app, desktop app, . . . etc.) specific guidance

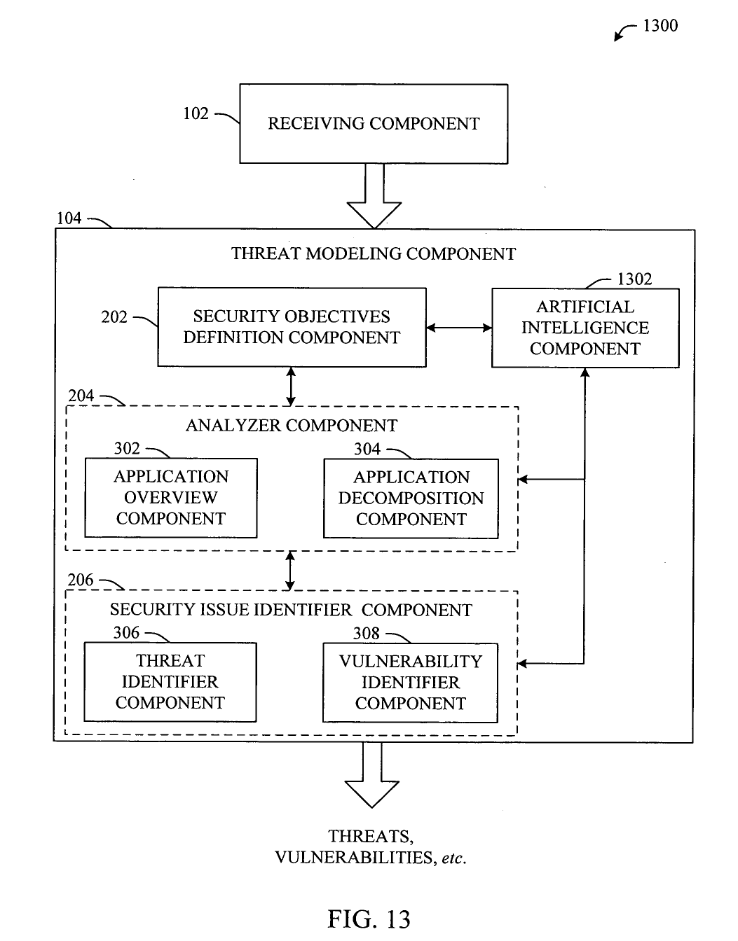

FIG. 13 illustrates a system 1300 that employs AI which facilitates automating one or more features in accordance with the subject innovation. The subject innovation (e.g., setting a baseline, objectives, tolerances, etc.) can employ various AI-based schemes for carrying out various aspects thereof. For example, a process for determining a baseline set of security objectives can be facilitated via an automatic classifier system and process.

A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria an appropriate set of baseline objectives as well as acceptable thresholds associated therewith.

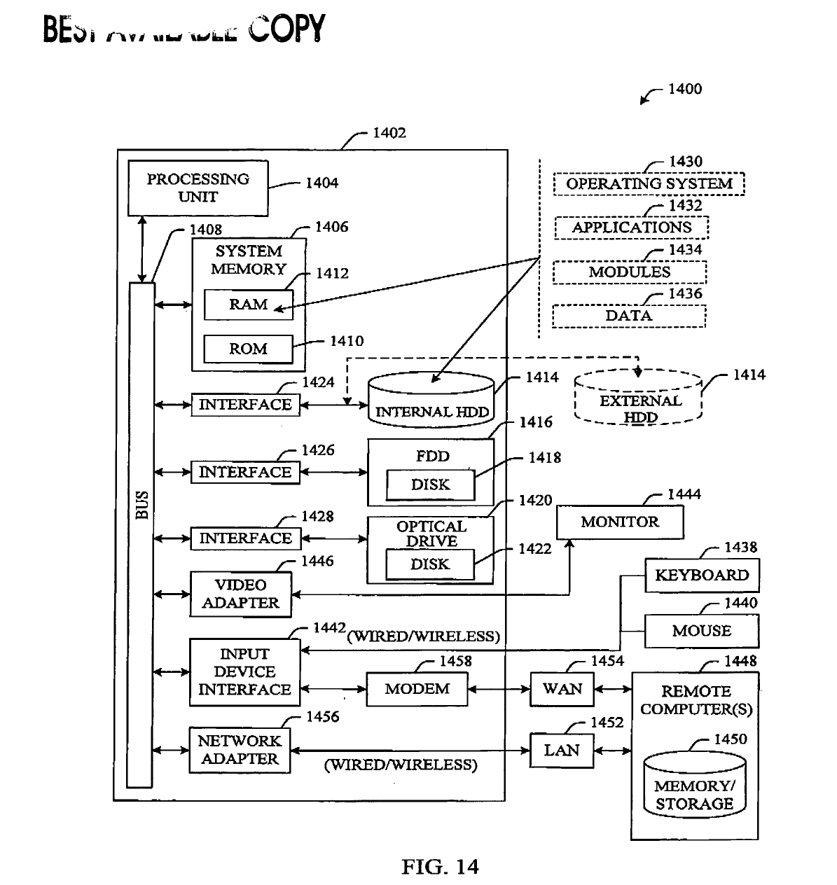

Referring now to FIG. 14, there is illustrated a block diagram of a computer operable to execute the disclosed architecture. In order to provide additional context for various aspects of the subject innovation, FIG. 14 and the following discussion are intended to provide a brief, general description of a suitable computing environment 1400 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 14, the exemplary environment 1400 for implementing various aspects of the innovation includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the innovation can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adapter 1456 may facilitate wired or wireless communication to the LAN 1452, which may also include a wireless access point disposed thereon for communicating with the wireless adapter 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

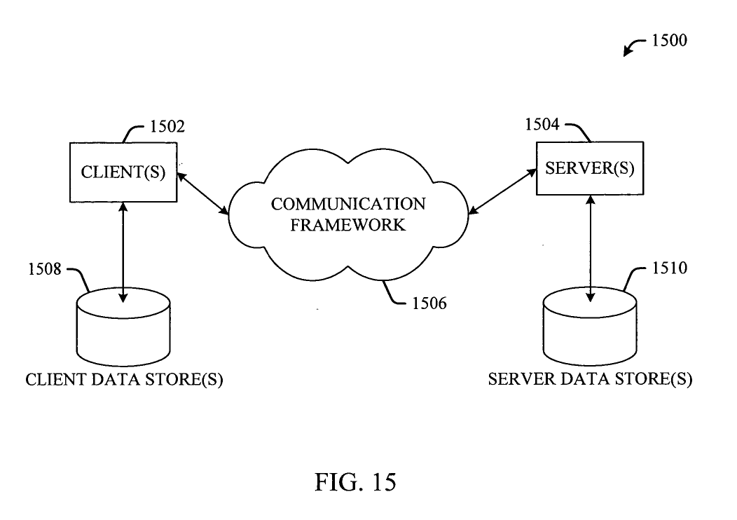

Referring now to FIG. 15, there is illustrated a schematic block diagram of an exemplary computing environment 1500 in accordance with the subject innovation. The system 1500 includes one or more client(s) 1502. The client(s) 1502 can be hardware and/or software (e.g., threads, processes, computing devices). The client(s) 1502 can house cookie(s) and/or associated contextual information by employing the innovation, for example.

The system 1500 also includes one or more server(s) 1504. The server(s) 1504 can also be hardware and/or software (e.g., threads, processes, computing devices). The servers 1504 can house threads to perform transformations by employing the innovation, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates security modeling of an application life cycle, comprising:
an input component that accepts an input; and
a threat modeling component that generates a threat model of the application life cycle based at least in part upon the input.

2. The system of claim 1, the input is a usage scenario based at least in part upon an architecture of the application.

3. The system of claim 2, the threat modeling component comprises a security objectives definition component that establishes a security objective based at least in part upon a criterion of the architecture.

4. The system of claim 3, the threat modeling component further comprises an analyzer component that analyzes the architecture and establishes the criterion.

5. The system of claim 4, the threat modeling component further comprises a security issue identifier that determines at least one of a threat and a vulnerability based at least in part upon the criterion.

6. The system of claim 5, the analyzer component comprises:
an application overview component that facilitates determination of application-specific factors that assist in determination of the one the threat and the vulnerability; and
an application decomposition component that assists in separating the application to facilitate a detailed examination of the threat.

7. The system of claim 6, the security issue identifier component comprises a threat identifier that determines the threat based at least in part upon the scenario.

8. The system of claim 7, the security issue identifier component further comprises a vulnerability identifier component that reviews one or more layers of the application and determines a weakness based at least in part upon the threat.

9. The system of claim 1, further comprising an artificial intelligence (AI) component that infers an action that a user desires to be automatically performed.

10. A computer-implemented method of modeling performance of an application, comprising:
identifying a usage scenario;
identifying a security objective based at least in part upon the usage scenario;
creating an overview of the application; and
identifying a threat based at least in part upon the overview.

11. The computer-implemented method of claim 10, further comprising decomposing the application to facilitate an examination of the threat.

12. The computer-implemented method of claim 11, further comprising reviewing at least one layer of the application and identifying a vulnerability associated with the threat.

13. The computer-implemented method of claim 12, the act of identifying the security objective comprises:
identifying data to protect;
identifying compliance requirements;
identifying quality of service requirements; and
identifying intangible assets to protect.

14. The computer-implemented method of claim 13, the act of creating an overview of the application comprises:
generating an end-to-end deployment scenario of the application;
identifying roles associated with the application;
identifying a key usage scenario;
identifying technologies associated with the application; and
identifying a plurality of application security mechanisms.

15. The computer-implemented method of claim 14, the act of identifying the threat comprises:
identifying at least one of a common threat and an attack;
identifying the threat based at least in part upon the usage scenario; and
identifying the threat based at least in part upon a data flow of the application.

16. The computer-implemented method of claim 15, the act of identifying the threat further comprises employing an attack tree that represents a goal of an attacker.

17. The computer-implemented method of claim 15, the act of decomposing the application comprises:
identifying a trust boundary of the application;
identifying the data flow of the application;
identifying an entry point of the application; and
identifying an exit point of the application.

18. A computer-executable system that facilitates security modeling of an application, comprising:
means for identifying a usage scenario associated with the application;
means for identifying a security objective based at least in part upon the usage scenario;
means for establishing an application overview;
means for generating a decomposition of the application to identify at least one of a trust boundary, a data flow, an entry point and an exit point; and
means for identifying a threat based at least in part upon one of the security objective, the application overview and the application decomposition.

19. The computer-executable system of claim 18, the means for establishing an overview is an end-to-end scenario diagram.

20. The computer-executable system of claim 19, the means for identifying a threat is an attack tree.
